(19) United States
(12) Patent Application Publication
(10) Pub. No.: US 2005/0174641 A1
(43) Pub. Date: Aug. 11, 2005

(54) Polarization conversion light integrator

(75) Inventors: Michael R. Greenberg, Santa Rosa, CA (US); Anthony D. McGettigan, Santa Rosa, CA (US); Markus Duelli, Santa Rose, CA (US); Curtis R. Hruska, Santa Rosa, CA (US); Benjamin F. Catching, Santa Rosa, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS UNIPHASE CORPORATION

(21) Appl. No.: 11/098,235

(22) Filed: Apr. 4, 2005

Related U.S. Application Data
(62) Division of application No. 10/304,300, filed on Nov. 26, 2002.

(51) Int. Cl. G02F 1/1335; G02B 5/30; G02B 27/28

(52) U.S. Cl. 359/486; 359/498

(57) ABSTRACT

A polarizing conversion system uses a polarizing beam splitter and reflector with a polarization conversion element to convert light from a lamp to a selected polarization state before providing the light to a light integrator, such as a light pipe or light tunnel. The light integrator provides homogenized polarized light to a light modulator. The polarization conversion system avoids increases efficiency compared to absorptive or simple reflective polarizers with fewer components than polarization conversion systems using patterned retarder plates and lenslet arrays. In one embodiment, the conversion elements are held to avoid adhesive or other bonds in the optical path. In other embodiments, high-temperature optical adhesive or optical contact bonding is used to assemble optical components for high-temperature operation. In a particular embodiment, a single-crystal quartz retarder plate is thermally matched to glass components in the polarization conversion system.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND

This invention relates generally to display systems, such as liquid crystal displays (“LCD's”) and projection displays, that use polarized light in applications such as color televisions, business projectors, and computer displays, and more particularly to a polarizing light integrator.

Most LCD projectors and projection systems use linearly polarized light at a light valve. The light valve is generally an array of reflective or transmissive pixels that turn on and off in a synchronized fashion to form an image from light that is illuminating the light valve. The image from the light valve is then typically focused onto a display screen.

It is desirable that the light illuminating a display screen have reasonably uniform intensity across the screen so that the resultant image is uniformly illuminated on the screen. One way to achieve uniform intensity over the area of a light valve is with a light pipe. Light pipes generally have an aperture at one end that admits light from a lamp or other light source. The light travels down the light pipe, reflecting off the walls of the light pipe, and exits the end of the light pipe. A light pipe can convert the circular cross section of the lamp output beam or arc image to the rectangular format and size of the light valve. The light can directly illuminate a light valve, or a lens system can be used to direct the homogenized light to the light valve. However, even with homogeneous light from a light pipe the brightness of the screen typically decreases from the center to the edge of the screen.

Light from the lamp is not linearly polarized. If linearly polarized light is required at the light valve, some method of polarization is needed. One way to achieve polarized light at the light valve is to remove light having the wrong polarization, thus providing light with the desired polarization to the light valve. The undesired light could be absorbed, reflected away, or transmitted to a termination while providing the light having the desired polarization to the light valve. This type of approach typically reduces the amount of light delivered from the lamp to the light valve by more than 50%.

Polarization conversion systems (“PCS's”) can recover most of the light that might otherwise be lost. A PCS generally converts the otherwise wasted light into light of the desired polarization. One technique is to use a flat PCS that combines the function of a light integrator (e.g. light pipe or light tunnel) with polarization conversion. Light integrators are used in projection displays to produce uniform illumination of the LCD light valve and thus essentially uniform illumination of the projection screen. A flat PCS might consist of two lenslet arrays (integrator plates or “fly's eyes”) and tall narrow beam splitters associated with each column of lenslets.

Each column-pair of the beam splitter array splits each of the virtual images of the lamp arc into two images with orthogonal linear polarization states. One polarization state is transmitted, the other is reflected. Columns of mirrors re-direct the reflected light in the direction of the transmitted light. A retarder rotates the polarization of one set of these images by ninety degrees, so that all the light is polarized in the same direction. Stripes of retarder plate material are cut and carefully aligned with the appropriate halves of the column-pairs of the beam splitter array to fabricate the retarder. Each lenslet in one array acts as a field lens and in conjunction with an auxiliary lens, images the light distribution at the first array onto the light valve.

Another approach is to use polarization recycling in a light integrator. In this technique, the unpolarized light from the arc-lamp enters the light integrator through an input aperture. The light is homogenized due to multiple internal reflections on its way to a reflective polarizer on the opposite end of the light pipe. The reflective polarizer at the exit face of the light integrator transmits one polarization state and reflects the other state back into the integrator. This light reflects off the input end of the integrator, with some loss through the input aperture, and is re-directed towards the reflective polarizer. The polarization state changes as a result of the multiple reflections; however, a retarder plate or other phase-shifting element can be included to enhance polarization conversion. Some portion of this re-circulated light is now in the correct polarization state to be transmitted through the polarizer, and the remainder is reflected of the polarizer again. This process repeats to enhance the amount of polarized light provided to the light valve.

Another polarization recovery technique converts the light to essentially a single polarization state before homogenizing the light in a light integrator. A polarizing beam splitter and retarder plate are used in the optical path between a tapered input light waveguide and an output light waveguide. The input light waveguide collects light from a dual-reflector light source and transforms the input light energy into a larger area with a small numerical aperture. The output light waveguide provides recovered polarized light output with a larger numerical aperture.

However, light pipes are relatively bulky and add to the component count and cost of the polarization recovery system. Similarly, each component presents an optical interface. In one system, the light waveguides are glued to the adjoining components with epoxy adhesive. Some epoxy adhesives work acceptably well at relatively low temperatures, but do not provide sufficient reliability at the high temperatures and light flux encountered in some display systems. Other epoxy adhesives work to higher temperatures, but are colored or tinted when cured, which affects the color balance of the light.

### SUMMARY OF THE INVENTION

The present invention provides compact, efficient polarization conversion of light for use in projection display systems and similar applications. In some embodiments, an input light waveguide is assembled to a polarizing beam splitter with a high-temperature optical bond, such as an optical contact bond or with a clear high-temperature optical adhesive. In other embodiments, the input light waveguide is omitted, and light from a lamp or other light source is provided to a polarizing conversion assembly optically coupled to a light integrator. A first polarizing beam splitter has a high angle of acceptance, avoiding the need for a small numerical input aperture and associated input light waveguide. The polarizing beam splitter splits the light into a selected polarization portion and a non-selected polarization portion. A retarder plate is disposed in the optical path of the light having the non-selected polarization state. The retarder plate is a quarter-wave plate in some embodiments, and a half-wave plate in other embodiments, depending on the configuration of the polarizing beam splitter.

### BRIEF DESCRIPTION OF THE DRAWINGS

FIG. 1A is a simplified cross section of a portion of a polarizing conversion system according to an embodiment of the present invention.

FIG. 1B is a simplified cross section of a portion of a polarizing conversion system according to another embodiment of the present invention.

FIG. 1C is a simplified cross section of a portion of a polarizing conversion system according to another embodiment of the present invention.

FIG. 1D is a simplified cross section of a portion of a polarizing conversion system using a wire-grid polarizer and mirror according to another embodiment of the present invention;

FIG. 1E is a simplified cross section of a polarizing conversion system using multiple mirrors to achieve polarization rotation according to another embodiment of the present invention.

FIG. 2 is a simplified side view of a stack of optical layers illustrating fabrication techniques of polarizing beam splitters according to embodiments of the present invention.

FIG. 3 is a simplified side view of a polarization conversion system illustrating arc image transmission, according to an embodiment of the present invention.

FIG. 4 is a simplified schematic diagram of a high-flux, high-temperature waveguide polarization recovery system according to embodiments of the present invention.

FIG. 5 is a simplified cross section of a multi-functional light recycling system according to an embodiment of the present invention.

FIG. 6A is a simplified side view of a brightness equalizing light recycling system according to an embodiment of the present invention.

FIG. 6B is a simplified end view of a brightness equalizing element according to an embodiment of the present invention.

FIG. 7A is a simplified schematic representation of a display system according to an embodiment of the present invention.

FIG. 7B is a simplified schematic representation of a scrolling color display system according to an embodiment of the present invention.

FIG. 8 is a simplified flow chart of a method of polarization conversion according to an embodiment of the present invention.

### DETAILED DESCRIPTION OF THE INVENTION

I. Introduction

Embodiments of the present invention provide polarization conversion systems for use in display systems and other applications. In some embodiments, light is directly coupled from a lamp system (arc and reflector) into the PCS without an input light pipe. A polarizing beam splitter with a wide acceptance angle provides efficient conversion and uniform contrast. The polarized light is provided to an output light integrator. In other embodiments, an input light pipe is used to illuminate the polarizing beam splitter with light having a small numerical aperture. High-temperature bonds in the optical path allow the PCS to work in systems having high flux and/or high operating temperatures.

Generally speaking, polarization recycling systems are particularly desirable for use with lamps having a small arc gap (≦1 mm) and larger panels (greater than about 20 mm), whereas PCSs might be preferable for use with lamps having larger arc gaps and with smaller panels. Polarization recycling systems typically have a superior extinction ratio, which is the ratio of light having the desired polarization to light having the undesired polarization state, compared to PCSs.

II. Exemplary Polarizing Conversion Systems

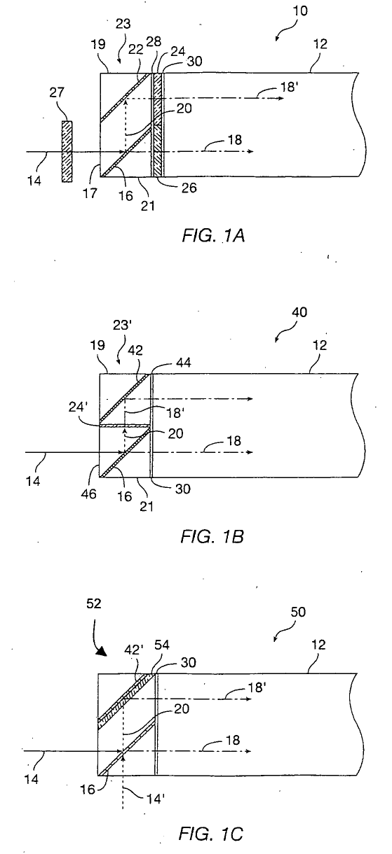

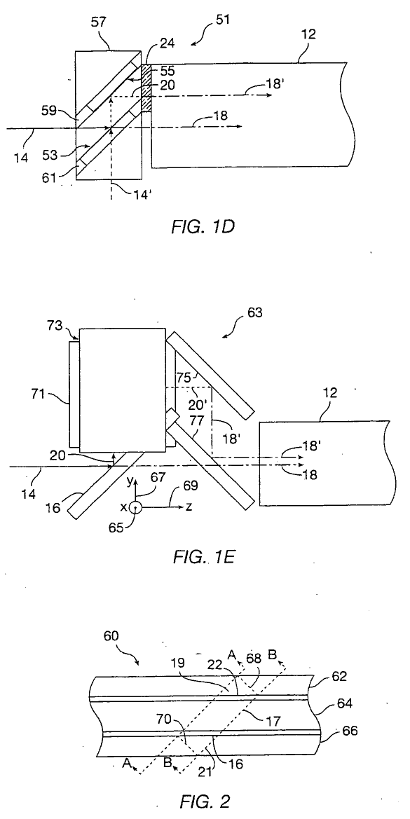

FIG. 1A is a simplified cross section of a portion of a polarizing conversion system 10 according to an embodiment of the present invention. The system includes a light integrator 12, such as a hollow light tunnel or a solid light rod. The light integrator may have any one of several suitable cross sections, generally adapted to the form of the subsequent light valve, and could be straight-sided or tapered. In a particular embodiment, the light integrator is an essentially rectangular light pipe fabricated from BK-7™ glass, which is available from SCHOTT GLASS TECHNOLOGIES INC. of Duryea, Pa. Other types of glass or polymer may be used to fabricate light pipes.

A light tunnel is generally a reflective tunnel, essentially a box of mirrors. Light entering one end reflects off the walls and becomes integrated (“homogenized”) to some degree before exiting the opposite end. A light pipe is similar in its result, but is solid and typically relies on total internal reflection (“TIR”) to reflect the light off the walls of the light pipe.

Light, represented by the solid arrow 14, from an arc lamp (not shown) illuminates a first polarizing beam splitter (“PBS”) 16. A reflector, such as an elliptic reflector, is typically used to focus the light from the lamp onto the PBS. In some embodiments, the PBS is a series of optical thin film layers that provides a wide acceptance angle (typically greater than 20 degrees and preferably greater than 30 degrees from the optimal angle of incidence to the surface of the PBS (typically 45 degrees), in other words from about 15-75 degrees from the surface). A high acceptance angle allows the PBS to efficiently polarize light received from lamp assembly without the use of an input light waveguide. Systems using input light waveguides typically use a MacNeille-type (thin film) PBS with a low acceptance angle because the input waveguide transforms the light into a larger area with a small numerical aperture. A PBS with a high acceptance angle avoids the requirement of using an input waveguide to provide a small numerical aperture. Conversely, a PBS with a low acceptance angle would not perform as well when receiving light directly from a lamp assembly because much of the light typically does not arrive at the optimal angle of incidence to the surface of the PBS. For adequate performance, a high-acceptance angle PBS should have an average transmission of Tₚ>80% and Tₛ<10% from 400-700 nm, and a cone angle of ±30 degrees (typically from a 45 degree angle of incidence relative to the surface of the PBS).

A PBS having a high acceptance angle may be made from a grid of fine wires (“wire-grid polarizer”) or a thin-film PBS may be made using layers of two or more materials deposited to satisfy the MacNeille condition. The PBS separates the light from the lamp into a first portion having a first polarization state, represented by the first dashed arrow 18, and reflects light of the other polarization state, represented by the dotted arrow 20 to a second PBS 22, which alternatively could be a mirror. This light is reflected off the second PBS 22 through a half-wave retarder plate 24.

The half-wave retarder plate 24 rotates the light to the desired polarization state, indicated by the second dashed line 18′. In particular embodiments the retarder plate is a true zero-order inorganic retarder plate, such as single-crystal quartz, mica, or birefringent glass. Unlike flat PCS systems, which spread out the flux from the lamp over a relatively large area, in the present example the lamp flux is present over the relatively small area of the two PBSs, which can attain an operating temperature of about 120° C., or even higher, depending on the lamp. The components and materials are chosen to withstand the light flux and temperature achieved during operation. While flat PCS systems typically use organic retarder material, such materials are generally undesirable for high-temperature polarization conversion systems. Lower operating temperatures might be obtained with suitable filtering of the lamp output, such as with an optional ultra-violet (“UV”) and/or infrared (“IR”) filter 26 between the lamp arc and the PBS, and allow the selection of a wider variety of materials.

The PBS coatings 16, 22 are typically coated on a glass prism 17 and held between glass end pieces 19, 21. This prismatic PBS assembly 23 is typically cut from a stack of optical glass layers, some of which include the PBS coatings. For example, the PBS coatings may be formed on the end pieces 19, 21, or both on the prism 17, or one coating on the prism and the other coating on an end piece. The prismatic PBS assembly, is discussed further in conjunction with FIG. 2, below.

The crystal orientation of the quartz plate is chosen to closely match the linear coefficient of thermal expansion (“CTE”) of the light pipe material. Quartz provides a particularly good CTE match to BK-7™ glass, and is particularly desirable for use in applications where the operating temperature might exceed 100° C. The thickness of the quartz is chosen to provide the desired retardation at the relevant wavelengths, and in a particular embodiment was about twenty-eight microns thick to provide a half-wave retardation. In alternative embodiments, the thickness of the retarder plate is chosen to provide retardation of N λ/2, where N is an odd, positive integer. The spectral distribution of the output of the conversion system can be selected in cases where N>1.

A micro-sheet of BK-7™ glass or other material is used as a spacer 26 to support the prismatic PBS assembly 23. The prismatic PBS assembly 23 is attached to the retarder plate 24 and spacer 26 by an adhesive layer 28 or other means, such as optical contact bonding. A second layer of adhesive 30 is used to attach the retarder plate 26 and spacer 26 to the end of the light pipe 12. Again, other assembly techniques, such as optical contact bonding, may be used. Similarly, the end of the light pipe can be stepped to avoid use of a spacer and eliminate a portion of the adhesive layer, or the void between the portion of prismatic PBS assembly under the first PBS 16 and light pipe could be filled with adhesive. Alternatively, the PBS assembly can be made out of individual prisms, avoiding the need for the microsheet. Similarly, the positions of the waveplate and the spacer could be swapped, so that the light transmitted by the PBS is converted to the polarization state of the light reflected by the PBS, which is directed into the light integrator without significant modification of its polarization state.

Adhesives used in such assemblies should be reliable over the operating temperature range of the assembly (e.g. about 120° C.) and not absorb UV light. UV-curable adhesives are not as desirable because they absorb UV light. Such adhesives tend to heat up and fail because of the high flux of light present, even with a UV filter 27 between the lamp arc and the adhesive. Adhesives belonging to the group of acrylates or the group of polysiloxanes are good candidates for this application, such as are available from NUSIL of Carpenteria, Calif. and ABLESTIK of Rancho Dominguez, Calif. In particular, adhesives exhibiting low light absorption in the short wavelength portion of the visible spectrum are generally desirable.

As an alternative to using an optical adhesive, parts may be assembled using optical contact bonding. Optical contact bonding generally involves bringing very flat, smooth surfaces together and directly bonding the materials together. In some instances, one or both surfaces might be activated, such as by plasma treatment, or coated with a thin layer of material that facilitates bonding. A simple drop of water may be placed between the surfaces in some instances, which are then squeezed together and optionally heat treated (e.g. about 400° C. for about 12 hours). It is believed that electro-static or Van der Waals forces hold the components together in some cases. In other cases, such as using water between two silicon-containing materials, it is believed that covalent (i.e. chemical) bonding might also occur to some extent.

In an alternative embodiment, the retarder plate could be in the optical path of the light transmitted by the first PBS and the light integrator, and the light reflected by the first PBS could be optically coupled to the light integrator, such as by reflection off the second PBS or mirror. In other words, the positions of the retarder plate 26 and glass spacer 26 could be swapped. For this light pipe, the polarization is essentially normal or parallel to the sides of the light pipe, thus polarization state change due to TIR is neglible.

FIG. 1B is a simplified cross section of a portion of a polarizing conversion system 40 according to another embodiment of the present invention. Light 14 is provided to the first PBS 16, which transmits light of a selected polarization 18 and reflects light of non-selected polarization 20. The light having non-selected polarization 20 is reflected to a half-wave retarder plate 24′, which is between the halves of the prismatic PBS assembly 23′. This assembly includes the PBS 16, and a mirror 42, glass prism pieces 44, 46, and end pieces 19, 21. A “mirror” could be a metallic reflector, or a series of dielectric thin film layers, as are well known in the art. With some mirrors, it may be possible to omit the end piece 19, which might otherwise be part of the optical design of a PBS or reflective thin film stack.

The half-wave retarder plate 24′ converts the polarization of the light reflected from the first PBS 16 to the desired polarization state, as indicated by the dashed arrow 18′. The prismatic PBS assembly is attached to a light integrator 12, such as a light pipe.

In this assembly, the CTE of the retarder plate is generally selected to match the CTE of the prism pieces 44, 46, and is illustrated as being contact bonded to the prism pieces. The prismatic PBS assembly 23′ is attached to the light pipe 12 with an adhesive layer 30, but may be contact bonded or otherwise assembled.

In an alternate embodiment, the prismatic PBS assembly is held in place relative to the light pipe or a light tunnel with a mechanical support, such as a surrounding tube or collar, and index-matching liquid or gel can be introduced between the light pipe and prismatic PBS assembly, thus allowing some degree of differential thermal expansion between the optical components. In the case of a light tunnel, the face(s) of the prismatic PBS assembly might be coated (e.g. with an anti-reflective coating) to improve light transmission from the assembly into the light tunnel. The collar may be glued to the components with an adhesive that does not have to be optically clear.

In a preferred embodiment, the light pipe, prism pieces, and end pieces are fabricated from the same glass, such as BK-7™, or glasses having similar CTEs. The half-wave retarder plate is preferably single-crystal quartz or other non-organic retarder material.

FIG. 1C is a simplified cross section of a portion of a polarizing conversion system 50 according to yet another embodiment of the present invention. The prismatic PBS assembly 52 includes a quarter-wave retarder plate 54 disposed at an angle to the light 20 reflected off the first PBS 16. Alternatively, a phase-control coating may be used. Placing such a coating at an angle to the light path(s) enhances the polarization conversion. Retarder plates, phase-control coatings and the like are generally referred to as polarization state modifier for purposes of discussion.

Light is retarded a quarter-wave as it passes to the mirror or second PBS 42′, and is retarded another quarter-wave as is passes through the plate from the mirror to the light pipe 12. Thus, the total retardation is one-half wavelength, and the desired polarization rotation is achieved to convert the non-selected light 20 to the selected polarization state, as represented by the dashed line 18′. In an alternative embodiment, light from the lamp, represented by the dashed arrow 14′, could come in at a right angle to light integrator in this embodiment or the embodiments shown in FIGS. 1A and 1B, among others.

FIG. 1D is a simplified cross section of a portion of a polarizing conversion system 51 using a reflective polarizer 53 as a PBS and a mirror 55 according to another embodiment of the present invention. The reflective polarizer could be a wire-grid polarizer, available from MOXTEK of Orem, Utah under the trade name PROFLUX™, for example. A wire-grid polarizer basically has a series of fine, closely spaced metal lines, or grid. Light 14 from a lamp or other light source is provided to the system. The polarizer transmits light of a selected polarization state 18 to the light integrator 12, and reflects light 20 having the non-selected polarization state. Unlike some other polarizing elements, wire grid polarizers do not have to be inclined 45 degrees from the incident light beam to achieve efficient operation, even though the PBS is illustrated in this respect in this example.

A bracket 57 holds the polarizer and mirror by their edges, without intervening glass blocks. The bracket may be made of metal, glass, or plastic, for example, and a second bracket would typically be used to hold the opposite edges of the optical components, but is not shown for clarity of illustration. In a particular embodiment, the bracket is cast or molded out of plastic or metal. The bracket has grooves 59, 61 that accept the optical components, which are typically fabricated on glass plates or slides. The optical components may be held in the grooves of the bracket mechanically, such as with a clamping or spring technique, or with adhesive. Since the adhesive is not in an optical path, it does not need to be clear. Use of the bracket avoids adhesive in the high-flux light path between the polarizing element and the mirror, as well as avoiding the need to fabricate the prismatic PBS assemblies, as discussed in relation to FIG. 2, below. The mirror may be either a front-surface or rear-surface mirror. If a rear-surface mirror is used, it may be desirable to include an anti-reflective coating on the front surface of the mirror.

A half-wave retarder plate 24 is coupled to the light integrator 12 to convert light 20 reflected off the polarizer 53 and mirror 55 to light of the desired polarization 18′. Alternatively, the half-wave retarder plate could be held in a third groove (not illustrated) in the bracket between the polarizer and mirror, or a quarter-wave retarder could be bonded to the mirror, which would act on the incident and reflected light. It may be desirable to include an anti-reflective coating on the input end of the light integrator if it is a solid rod.

FIG. 1E is a simplified cross section of a polarizing conversion system 63 using multiple mirrors to achieve polarization rotation according to another embodiment of the present invention. A PBS 16 transmits light 18 having the selected polarization to the light integrator 12, and reflects light 20 having non-selected polarization to a mirror system that uses three mirrors to covert light of the non-selected polarization 20 to light of the desired polarization 18′.

The arrangement of three mirrors is difficult to illustrate in a two-dimensional drawing, and is more easily understood with reference to coordinate axes, x, y, z. The x axis 65 is normal to the plane of the sheet of the illustration, they axis 67 runs up and down the sheet, and the z axis 69 runs left and right. These coordinates are chosen merely for purposes of illustration and are not limiting. Similarly, the order of mirrors is not limiting, as long as the desired polarization shift is achieved with the system.

The first mirror 71 is rotated (tilted) 45 degrees around the z axis, and reflects the light 20 in the x direction to the second mirror 73, which is rotated 45 degrees around they axis and reflects light in the z direction. Polarization shifting occurs upon each reflection to produce partially shifted light 20′ that is provided to the third mirror 75, which is rotated 45 degrees around the x axis and reflects light in the y direction. In other words, the light is converted to a first intermediate polarization state after reflecting off the first mirror, and to a second intermediated polarization state after reflecting off the second mirror. The third mirror converts the light to the desired polarization state, which is typically orthogonal to the polarization of the incoming light.

A fold mirror 77, which is substantially parallel to the third mirror 75 and therefore does not further shift the polarization state of the light, directs the light 18′ to the light integrator 12. The two beams 18, 18′ are now “on top” of each other, rather than “side-by-side”, as in FIGS. 1A-1D. Thus, it is possible to provide a polarization conversion system without adhesive in the optical path, using mirrors to shift the polarazation state.

In practice, the three-mirror system might be fabricated as a single part, such as by casting or machining a solid optical element from plastic or glass, and providing reflectors on facets of the solid piece. The reflectors could be simply thin-film metal layers, or dielectric mirror stacks. A PBS could also be incorporated on a face of the solid piece to provide a rugged polarization conversion component without adhesive in the optical path, which could be mechanically mounted to direct polarized light into the light integrator. Alternatively, the solid polarization conversion component could be glued or contact bonded to a light rod.

FIG. 2 is a simplified side view of a stack of optical layers 60 illustrating fabrication techniques of prismatic PBS assemblies according to embodiments of the present invention. Thin sheets of optical glass 62, 64, 66 are stacked with intervening layers or coatings, such as PBS coatings 16, 22. The layers are typically contact bonded, but could be adhesively bonded. Coatings are typically formed on one of the sheets of glass, but could be freestanding structures. As discussed above in conjunction with FIGS. 1A-1C, layers may be substituted or added. For example, a PBS coating might be replaced with a mirror coating or stack, and a retarder plate or phase-shifting coating might be included in the assembly (see, e.g. FIG. 1C, ref. num. 54).

The stack is cut along section lines A-A, B-B and the corner pieces 19, 21 can be cut or ground along dotted lines 68, 70 to result in a generally box-like structure for attachment to a light tunnel. Alternatively, the corner pieces can be chamfered, or even omitted in some instances, such as when they do not form part of the optical design.

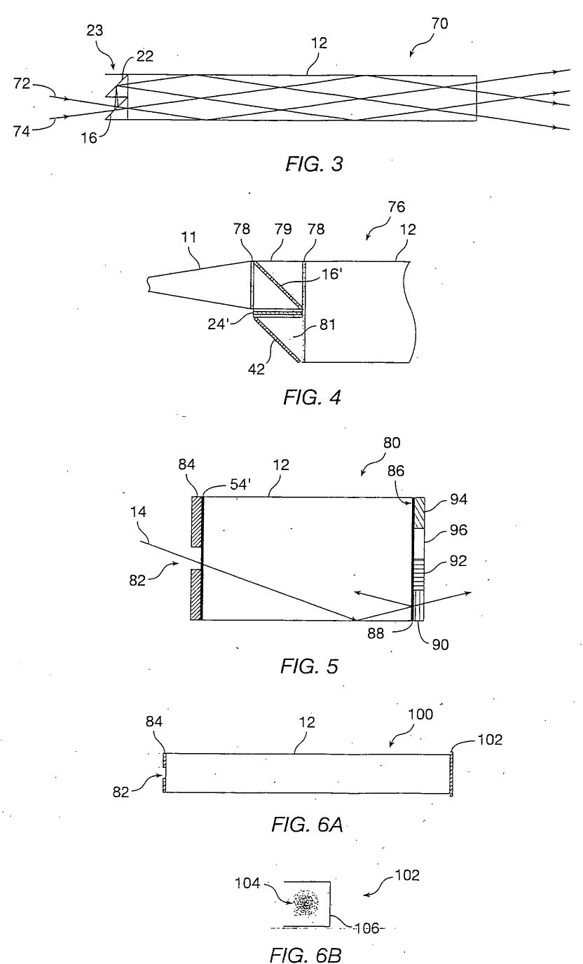

FIG. 3 is a simplified side view of a light integrator assembly 70 illustrating arc image transmission, according to an embodiment of the present invention. In some systems, two arc images, represented by arrows 72, 74, are received from the lamp (not shown). The arrows indicate two rays from the light cone coming from the lamp. They indicate where the focus ideally should be to couple most of the light into the light pipe. Each arc image illuminates a different area of the first PBS 16, but the non-selected light from these two images is reflected to essentially the same area of the second PBS 22 of the prismatic PBS assembly 23. The light from the two arc images is homogenized as it travels down the light integrator 12, illustrating that a polarization system with the PBSs at the input end of the integrator does not increase the entendue compared to a light integrator without the PB Ss at the input. No polarization recycling takes place, and no input aperture, reflective input end, or reflective polarizer are needed. Losses associated with multiple transmissions through the light integrator and loss out the aperture are avoided, compared with a recirculating polarization light recovery system.

FIG. 4 is a simplified schematic diagram of a waveguide polarization recovery system 76 according to an embodiment of the present invention that can use a PBS with either a wide or narrow angle of acceptance, and that is suitable for use in high flux/high temperature applications. An input light pipe 11 provides light to the PBS 16′ with a relatively small numerical aperture, which can improve contrast uniformity and polarization efficiency of the PBS in some embodiments, particularly embodiments using a PBS with a narrow acceptance angle. Such systems are known; however, their use at high temperatures, which are typically associated with high-flux light sources is limited.

In particular, epoxy has been used in the optical path to assemble polarization recovery systems. While optical epoxies are suitable for low temperature bonds, many fail at high (greater than about 120° C.) temperatures. “Optical” epoxies are available that are rated for temperatures up to 130° C.; however, such epoxies are typically blue or red when cured. Color in the optical path can result in the colorant absorbing light energy, which causes local heating. This heating can degrade the adhesive properties of the epoxy, and can contribute to problems arising from thermal mismatch, which can further affect the bond interface. Therefore, it is desirable to assemble the PCS using clear, high-temperature bonding techniques.

A clear, high-temperature optical adhesive 78, as described above in relation to FIG. 1A, is used to assemble the prismatic PBS assembly 79, which includes the PBS, to the input light pipe 11, output light pipe 12, half-wave retarder plate 24′ and mirror 42. Alternatively, optical contact bonding may be used instead of optical adhesive to form a high-temperature bond. As used herein, a “high-temperature bond” is a bond that provides reliable optical performance at a temperature of 100° C. for at least 1000 hours of operation. Optical contact bonding works well between silica-based materials and avoids the intervening layer of polymer adhesive, which often has a high CTE. If it is desired to contact bond non-silica based materials, a thin (sub-optical) layer of silica may be formed on the component to facilitate bonding. In particular embodiments, the input light pipe, output light pipe, prismatic assembly, and mirror prism 81 are made of glass having essentially the same CTE to reduce thermally induced stress. In a further embodiment, the retarder plate is made of an inorganic material having essentially the same CTE. In a particular embodiment, the glass portions of the PCS are fabricated from BK-7™ glass and the retarder plate is quartz. Matching the CTE of the components avoids thermal stresses, which can crack brittle optical components and de-laminate bonds.

Other glasses may be substituted, and other retarder plates, such as mica or polymer retarder plates, may be used. A combination of high-temperature bonds types may be used to fabricate the PCS, such as using contact bonding where appropriate, and adhesive bonding elsewhere. For example, if a polymer or mica retarder plate is used, adhesive can be limited to bonding the retarder plate to the opposing glass prism pieces.

Several other configurations of high-temperature PCSs are possible. For example, the retarder plate could be placed between the mirror and the output waveguide, similar to FIG. 1A, or a quarter-wave retarder plate could be placed as in FIG. 1C. Similarly, the input light pipe could be oriented at an angle to the output light pipe.

III. An Exemplary Multi-Functional Light Recycling System

Color recycling generally requires an input aperture and surrounding reflector, so in these cases a different PCS may be desirable. Combined color and polarization recycling is particularly desirable in 1- and 2-panel LCD projection systems that use scrolling color, either by employing a scrolling color-recycling (“SCR”) colorwheel or a dichroic stripe light pipe with a rotating prism or mirror drum.

FIG. 5 is a simplified cross section of a multi-functional light recycling system 80 according to an embodiment of the present invention. Light 14 is coupled into the light integrator 12 through an input aperture 82. A reflector 84 surrounds the input aperture, which can be a metallic reflector or a dielectric thin film stack, for example. The aperture could be at a corner or edge of the input face, in which case it would not be surrounded by the reflector. The light travels down the integrator, reflecting off the walls (interfaces) and is spatially homogenized. In other words, light from the arc image illuminates the exit end 86 of the light pipe with essentially uniform intensity. A reflective polarizer 88 is placed after the exit end of the light integrator, as are dichroic filters 90, 92, 94. One type of reflective polarizer is commonly called a wire-grid polarizer, such as are sold under the trade name PROFLUX™ by MOXTEK of Orem, Utah. A clear section 96 may be included to increase the brightness of the eventual image on the display screen, and may be either a piece of clear glass, or an uncoated area. Although the dichroic filters are shown as being separate from the reflective polarizer, a polarization structure could be formed on one side of a common substrate, and the filters formed or attached to the opposite side of the common substrate.

The dichroic filters are generally filters that transmit light of a selected color or colors and reflect light of non-selected colors. For example, the filters could be red 90, green 92, and blue 94, or yellow and magenta filters could be used in a system where red does not scroll, or cyan and magenta in a system where blue does not scroll, for example. The color filters can be placed before or after the reflective polarizer, relative to the exit face 86 of the light integrator. Red light falling on the red filter 90, for example, is transmitted through the filter and the remaining light is reflected back into the light integrator 12. The reflected light is homogenized and reflects off the reflector 84 on the input end, with some of the light being lost out the aperture 82. The remaining light is reflected back toward the color filters, so that a portion of the remaining light originally reflected off the red filter will illuminate the other color filters and clear section, if present, and be transmitted toward the display screen (not shown). The process of back reflection, homogenization and re-illumination repeats to increase the light output of the integrator. This is known as “recycling”, “recirculating” or “recapturing” light.

Similarly, the reflective polarizer 88 transmits light having a selected polarization state and reflects light having a non-selected polarization state back into the light integrator 12. The light integrator homogenizes the back-reflected light and some polarization shift occurs from the multiple reflections. An optional retarder plate 54, or phase-shifting coating may be added in the optical path between the input reflector 84 and the reflective polarizer 88. Back-reflected light travels through the retarder plate twice before returning to the reflective polarizer, thus a quarter-wave retarder plate or retarder plate being an odd multiple of a quarter-wave plate is desirable if little polarization shift otherwise occurs in the integrator. The polarization state of a portion, perhaps most, of the back-reflected light is converted to the selected polarization state before it returns to the reflective polarizer 88, where it is transmitted.

In an alternative embodiment, the retarder plate is omitted and the light pipe is made of birefringent glass. The birefringent glass provides modification of the polarization state of the light transmitted through the birefringent glass. In a particular embodiment, the length of the light pipe of birefringent glass is selected to provide about one quarter-wave of retardation.

It is estimated that up to 35% of the usable light arriving at the aperture can be provided to the light valve with color and polarization recycling (with no clear section 96 in the color filter plane). In comparison, it is estimated that only about 16% of the light would be available if an absorptive polarizing filter and absorptive color filters were used (i.e. without light recycling). Further discussion of such a system is found in U.S. patent application Ser. No. 10/262,539 entitled SCROLLING COLOR PROJECTION SYSTEM, filed Oct. 1, 2002 by Anthony D. McGettigan and Markus Duelli, the disclosure of which is hereby incorporated in its entirety for all purposes.

IV. A Brightness Equalizing Light Recycling System

FIG. 6A is a simplified side view of a brightness equalizing light recycling system 100 according to an embodiment of the present invention. A light integrator 12 has an aperture 82 and reflector 84 at its input end, and a spatially variable reflective transmitter 102 at its exit end. Although the integrator provides homogeneous illumination of the light valve, the brightness of the screen typically decreases from the center of the screen to its edge. This is due to the limitations of typical optical systems and the imaging of the light valve or micro-display onto a flat screen. A more uniform brightness on the display screen can be achieved by illuminating the light valve with a non-uniform intensity distribution, i.e. darkening the center relative to the edges.

The spatially variable reflective transmitter provides relatively more shading in the center of the exit face of the light pipe than at its edges. Unlike a simple absorptive filter that removes light from the center portion of the field, the reflective transmitter recycles this light that would otherwise be lost back into the integrator. Thus the center is darkened relative to the edge(s) without losing as much light. This provides a brighter display, or allows other design choices to be made, such as selecting a lamp having lower power requirements or longer lifetime, for example.

FIG. 6B is a simplified end view of a brightness equalizing element 102 according to an embodiment of the present invention. A spatially variable reflective filter 104 is formed on a glass substrate 106, or could be formed directly on a light pipe, or on a dichroic filter plate, or a polarizer, or even on a retarder plate placed between the polarizer and the light pipe, for example. The filters could be formed from very small dots of metal, for example, that reflect essentially all light falling on the dot back into the light pipe. The pattern is alternatively created by coating a mirror (metallic or dielectric) and using photolithography techniques to define a dot pattern. The dots could be opaque, or partially transmissive. In a particular embodiment, the spatial light distribution of light exiting the light pipe follows 1−cos²(r), where r is the radius from the center of the pipe or display screen.

The order of light recycling elements, such as a spatially variable filter, reflective polarizer, and dichroic filters may be chosen according to desired light characteristics.

V. Exemplary Display Systems

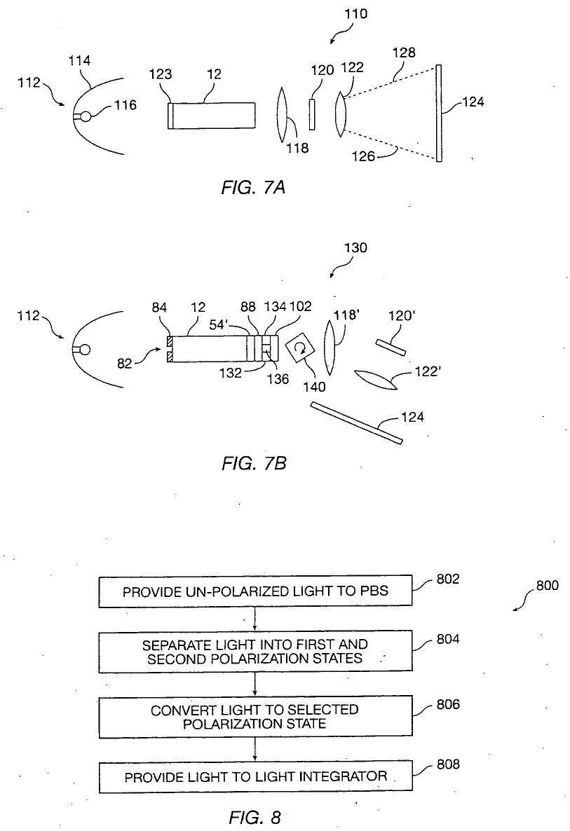

FIG. 7A is a simplified schematic representation of a display system 110 according to an embodiment of the present invention. A lamp 112 with a focusing reflector 114 directing light from an arc or filament 116 provides a broad spectrum of unpolarized light to a prismatic PBS assembly 123 that is optically coupled to a light integrator 12. The prismatic PBS assembly transmits light of a selected polarization to the light integrator, and converts light having non-selected polarization to the desired polarization state before transmitting it to the light integrator. Thus, most of the light exiting the light integrator has the desired polarization state.

The polarized light exits the light pipe to a lens 118 that collimates and focuses the beams onto a light valve 120. The modulated light from the light valve is collected and focused by a projection lens 122 to a display screen 124, as represented by the dashed lines 126, 128.

FIG. 7B is a simplified schematic representation of a scrolling color display system 130 according to an embodiment of the present invention. The lamp 112 provides broad-spectrum light to a light integrator 12 with color filters 132, 134, 136 on the exit face, and an aperture 82 and reflector 84 on its input face. Thus, the system can recycle light in the integrator. A clear field (not shown, see FIG. 4, ref. num. 96) may be provided in addition to the color filters. The color filters could be red, green, and blue, cyan and magenta, yellow and cyan, or yellow and magenta, for example. The choice of colors is only exemplary. It is not necessary to limit the filter colors to the primary colors or their compliments.

A reflective polarizer 88 and optional retarder plate 54′, typically about a quarter-wave plate, are provided to convert back-reflected light to the desired polarization state in the recycling light integrator. A reflective brightness equalizer 102 may be included, as discussed above in conjunction with FIGS. 5A and 5B.

A rotating prism 140 scrolls the polarized color beams. The lens 118′ focuses the scrolling and any non-scrolling beams on a light valve 120′. The light valve could be a reflecting liquid crystal device, such as a liquid crystal on silicon (“LCoS”) or ferroelectric LCD (“FLCD”) device, or other light valve or spatial light modulator using polarized light. Transmissive light valves could be used with appropriate optics and configuration. A projection lens 122′ directs the image from the light valve to the display screen 124.

VI. Exemplary Methods

FIG. 8 is a simplified flow chart of a method of polarization conversion 800 according to an embodiment of the present invention. Light having a plurality of polarization states is provided directly from a lamp system to a PBS having a wide acceptance angle (step 802). The polarizing beam splitter transmits light having a first polarization state (step 804), and essentially concurrently reflects light having a second polarization state (step 806). The portion of the light having the first polarization state is converted to the second polarization state (or vice versa) to convert the light into the selected polarization state (step 808) and the light having the selected polarization state is provided to the light integrator (step 810). In a particular embodiment, the light reflected in step 806 is reflected to a second PBS, which reflects the light to a half-wave retarder plate or other polarization state modifier. The half-wave retarder plate converts the light to the selected polarization state before it is provided to the light integrator. In an alternative embodiment, the light reflected in step 806 is reflected to a mirror that reflects it through a half-wave retarder plate into the light integrator. In yet another embodiment, a half-wave retarder plate is disposed in the path of the reflected light between the first PBS and the second PBS or mirror. In another embodiment, a quarter-wave retarder plate or other polarization state modifier is configured so that light reflected from the first PBS passes through the polarization state modifier twice before entering the light integrator. In a further embodiment, the light entering the integrator passes through optical adhesive that does not absorb significantly UV light. In other words, any UV absorption does not render the adhesive inoperative or significantly reduce its optical performance or reliability.

While the invention has been described above in terms of various specific embodiments, the invention may be embodied in other specific forms without departing from the spirit of the invention. Thus, the embodiments described above illustrate the invention, but are not restrictive of the invention, which is indicated by the following claims. All modifications and equivalents that come within the meaning and range of the claims are included within their scope.

1-26. (canceled)

27. A polarization conversion system comprising:
a polarizing beam splitter having an acceptance angle greater than 20 degrees configured to receive light from a light source and to optically couple a first portion of light having a first polarization state to
a light integrator, and the first polarizing beam splitter configured to optically couple a second portion of light having a second polarization state to
a polarization state modifier, the polarization state modifier converting the second portion of light to the first polarization state and configured to optically couple the second portion of light to the light integrator, wherein the polarization state modifier comprises three mirrors.

28. A polarization conversion element comprising:
a polarization beam splitter configured to receive light having a first polarization state and a second polarization state, the polarization beam splitter transmitting a first portion of light having the first polarization state and reflecting a second portion of light having the second polarization state to
a first mirror configured to reflectively convert the second portion of light to a first intermediate polarization state between the first polarization state and the second polarization state;
a second mirror configured to receive the second portion of light having the first intermediate polarization state and to reflectively convert the second portion of light to a second intermediate polarization state between the first polarization state and the second polarization state; and
a third mirror configured to reflectively convert the second portion of light having the second intermediate polarization state to the first polarization state.

29. The polarization conversion element of claim 28 wherein the first mirror, the second mirror, and the third mirror are formed on a first facet, a second facet, and a third facet of a solid optical element.

30. The polarization conversion element of claim 29 wherein the polarization conversion beam splitter is disposed on a fourth facet of the solid optical element.

31. The polarization conversion element of claim 30 wherein the polarization conversion beam splitter is formed on the fourth facet of the solid optical element.

32. A polarization conversion element comprising:
a solid optical element having
an input face,
a first reflector disposed on a first facet,
a second reflector disposed on a second facet,
a third reflector disposed on a third facet, and
an output face, the input face being configured to accept light having a first polarization state, and to optically couple the light having the first polarization state to the first reflector, the first reflector reflectively converting the light to a first intermediate polarization state and optically coupling the light having the first intermediate polarization state to the second reflector, the second reflector reflectively converting the light to a second intermediate polarization state and optically coupling the light having the second intermediate polarization state to the third reflector, the third reflector reflectively converting the light to a second polarization state essentially orthogonal to the first polarization state and optically coupling the light to the output face.

33. A polarization recovery apparatus comprising: a polarizing beam splitter transmitting a light of a useful polarization in an output direction and reflecting a light of a non-useful polarization in a first orthogonal direction substantially orthogonal to said output direction; an initial reflector disposed reflectably to said first orthogonal direction, said initial reflector reflecting said non-useful polarization light in a second orthogonal direction substantially orthogonal to said output direction and said first orthogonal direction; and a final reflector disposed reflectably to said second orthogonal direction, said final reflector reflecting said non-useful polarization light in said output direction; wherein said non-useful polarization light is rotated substantially to light of said useful polarization by said initial and final reflectors; said apparatus comprising further: a first output reflector disposed reflectably to said output direction, said first output reflector reflecting said useful polarization light in said second orthogonal direction; and a second output reflector disposed reflectably to said second orthogonal direction, said second output reflector reflecting said useful polarization light in said output direction.

34. The polarization recovery apparatus of claim 33, wherein said first output reflector is selected from the group consisting of: a right angle prism, and a mirror.

35. The polarization recovery apparatus of claim 33, wherein said second output reflector is selected from the group consisting of: a right angle prism, and a mirror.

36. The polarization recovery apparatus of claim 33, comprising further: an output light pipe having an input surface disposed proximate to said output direction and an output surface, said output light pipe receiving said useful polarization light at said input surface and transmitting said useful polarization light at said output surface.

37. The polarization recovery apparatus of claim 33, wherein said polarizing beam splitter comprises a wire-grid polarizing beam splitter.
